(19) United States
(12) Patent Application Publication
(10) Pub. No.: US 2026/0077775 A1
(43) Pub. Date: Mar. 19, 2026

(54) VEHICLE MOBILITY CAPABILITY ENGINE AND ASSOCIATED METHODS

(71) Applicant: Ares Technology, LLC, Sterling Heights, MI (US)

(72) Inventors: Eric Patton, Sterling Heights, MI (US); Scott Tarlow, Los Angeles, CA (US)

(21) Appl. No.: 19/329,989

(22) Filed: Sep. 16, 2025

Related U.S. Application Data
(60) Provisional application No. 63/695,068, filed on Sep. 16, 2024.

(51) Int. Cl. B60W 50/02; B60W 50/00; G06N 3/04; G06N 3/08

(52) U.S. Cl. CPC B60W 50/0205; B60W 50/0097; G06N 3/04; G06N 3/08; B60W 2050/0215; B60W 2520/14; B60W 2520/16; B60W 2520/18

(57) ABSTRACT

A method for determining health for a vehicle may include training at least one machine learning model with a set of data associated with traversal of a vehicle. The method may include determining, using the trained at least one machine learning model, one or more parameters associated with the one or more vehicle components in response to operation of the vehicle. A system for determining vehicle mobility is also disclosed.

### CROSS-REFERENCE TO RELATED APPLICATION

This application claims the benefit of U.S. Provisional Application No. 63/695,068, filed on Sep. 16, 2024, which is incorporated herein in its entirety.

### BACKGROUND

This disclosure relates to vehicle mobility.

Vehicle diagnostics is known and includes a determination of component and/or system degradation based on collected information. Prognostics includes predicting component and/or system degradation based on collected information. The information may be obtained from one or more sensors that measure a condition of the components during vehicle operation. A known technique uses machine learning with inertial sensors on a hull of the vehicle to detect failure of a shock absorber.

### SUMMARY

A method for determining health for a vehicle may include training at least one machine learning model with a set of 2D symmetric data and a set of 2D asymmetric data. The set of 2D symmetric data may be associated with traversal of a vehicle along one or more first routes. The at least one machine learning model may include an input layer and an output layer. The input layer may include input nodes that may be associated with one or more vehicle components of the vehicle. The method may include determining, using the trained at least one machine learning model, one or more parameters associated with the one or more vehicle components in response to operation of the vehicle. The vehicle may include a left side and a right side. The left and right sides may include one or more respective wheels. The one or more first routes may be linear such that the set of 2D symmetric data may include values associated with pitch but may lack values associated with roll or yaw of the vehicle. The set of 2D asymmetric data may include values associated with pitch and roll but may lack values associated with yaw of the vehicle.

In any implementations, the method may include obtaining virtual sensor information from one or more virtual sensors operable to measure a condition of a virtual instance of the respective one or more vehicle components. The training step may include training the at least one machine learning model with the virtual sensor information.

In any implementations, the set of 2D symmetric data may be established such that values associated with the left and right sides may be equal to each other.

In any implementations, the method may include training the at least one machine learning model with a set of 3D data associated with traversal of the vehicle along one or more second routes. The one or more second routes may include one or more undulations such that the set of 3D data may include values associated with yaw, pitch and roll of the vehicle.

In any implementations, the method may include training the at least one machine learning model with terrain data associated with the one or more first routes and/or the one or more second routes.

In any implementations, the one or more first routes and/or the one or more second routes may be associated with different terrain profiles relative to the left side and the right side. The set of 2D asymmetric data and the set of 3D data may be established such that values associated with the left side may differ from values associated with the right side in response to variation between the terrain profiles during traversal of the vehicle along the respective one or more first and second routes. More than half of the training data utilized to train the at least one machine learning model, subsequent to training the at least one machine learning model with the set of 3D data, may include the set of 2D symmetric data and/or the set of 2D asymmetric data.

In any implementations, the method may include generating the set of 2D symmetric data. The method may include generating the set of 2D asymmetric data. The method may include generating the set of 3D data.

In any implementations, the method may include obtaining virtual sensor information from one or more virtual sensors operable to measure a condition of a virtual instance of the respective one or more vehicle components. The method may include generating the set of 2D symmetric data. The set of 2D asymmetric data and/or the set of 3D data may be based on the virtual sensor information.

In any implementations, the at least one machine learning model may include first, second and third machine learning models. The step of training the at least one machine learning model with the set of 2D symmetric data may include training the first machine learning model. The step of training the at least one machine learning model with the set of 2D asymmetric data may include training the second machine learning model. The step of training the at least one machine learning model with the set of 3D data may include training the third machine learning model. One or more output nodes of the first machine learning model and one or more output nodes of the second machine learning model may be connected to respective input nodes of the third machine learning model. The determining step may be performed by the third machine learning model based on one or more outputs of the first machine learning model and one or more outputs of the second machine learning model.

In any implementations, the method may include obtaining real sensor information measured by one or more physical sensors during vehicle operation. The training step may include training the at least one machine learning model with the real sensor information.

In any implementations, the method may include determining a health of a physical instance of the respective one or more vehicle components based on the trained at least one machine learning model. The method may include predicting the health of the physical instance of the respective one or more vehicle components based on the trained at least one machine learning model.

In any implementations, the at least one machine learning model may include an artificial neural network. The at least one machine learning model may include one or more intermediate layers. The one or more intermediate layers may include one or more recursion layers, one or more transformers and/or one or more convolution layers. The at least one machine learning model may include a time-series type model.

In any implementations, the one or more determined parameters may include wheel motion, hull motion, absorbed power, and/or damping with respect to absorbed power.

In any implementations, a first instance of the at least one machine learning model may be associated with a first vehicle component. A second instance of the at least one machine learning model may be associated with a second vehicle component. The first and second components may be associated with a common side of the vehicle. The first instance of the at least one machine learning model may establish a first digital twin that may be utilized to determine the one or more parameters associated with the second vehicle component. The second instance of the at least one machine learning model may establish a second digital twin that may be utilized to determine the one or more parameters associated with the first vehicle component.

In any implementations, the method may include determining, using the trained machine learning model, a route plan based on the determined one or more parameters.

In any implementations, the method may include communicating terrain data from a physics-based engine. The method may include communicating the terrain data to the input layer of the trained machine learning model. The method may include determining, using the trained machine learning model, the one or more parameters based on the terrain data. The method may include communicating the one or more determined parameters to the physics-based engine.

A system for determining vehicle mobility may include a computing device that may include one or more processors coupled to memory. The one or more processors may be collectively operable to execute a vehicle mobility capability engine. The vehicle mobility capability engine may be operable to train at least one machine learning model with a set of 2D symmetric data and/or a set of 2D asymmetric data that may be associated with traversal of a vehicle along one or more first routes. The at least one machine learning model may include an input layer and an output layer. The input layer may include input nodes that may be associated with one or more vehicle components of the vehicle. The vehicle mobility capability engine may be operable to determine, using the trained machine learning model, one or more parameters that may be associated with the one or more vehicle components in response to operation of the vehicle. The vehicle may include a left side and a right side. The left and right sides may include one or more respective wheels. The one or more first routes may be linear such that the set of 2D symmetric data may include values associated with pitch but may lack values associated with roll or yaw of the vehicle. The set of 2D symmetric data may be established such that values associated with the left and right sides may be equal to each other. The set of 2D asymmetric data may be established such that values associated with the left side may differ from values associated with the right side.

In any implementations, the vehicle mobility capability engine may be operable to train the at least one machine learning model with the set of 2D symmetric data and the set of 2D asymmetric data.

In any implementations, the vehicle mobility capability engine may be operable to train the at least one machine learning model with a set of 3D data that may be associated with traversal of a vehicle along one or more second routes. The set of 3D data may be established such that values associated with the left side may differ from values associated with the right side. The one or more second routes may be non-linear such that the set of 3D data may include values associated with yaw, pitch and roll.

In any implementations, the vehicle mobility capability engine may be operable to determine, using the trained machine learning model, a route plan based on the one or more parameters.

A method for determining health for a vehicle may include training at least one machine learning model with a set of 2D symmetric data associated with traversal of a vehicle along one or more first routes. The at least one machine learning model may include an input layer and an output layer. The input layer may include input nodes associated with one or more vehicle components of the vehicle. The method may include training the at least one machine learning model with a set of 3D data associated with traversal of a vehicle along one or more second routes. The method may include determining, using the trained at least one machine learning model, one or more parameters associated with the one or more vehicle components in response to operation of the vehicle. The vehicle may include a left side and a right side. The left and right sides may include one or more respective wheels. The one or more first routes may be linear such that the set of 2D symmetric data may include values associated with pitch but may lack values associated with roll or yaw of the vehicle. The one or more second routes may include one or more undulations such that the set of 3D data include values associated with yaw, pitch and roll.

In any implementations, the method may include training the at least one machine learning model with a set of 2D asymmetric data that may include values associated with pitch and roll but may lack values associated with yaw of the vehicle. The set of 2D symmetric data may be established such that values associated with the left and right sides may be equal to each other. The one or more first routes and/or the one or more second routes may be associated with different terrain profiles relative to the left side and the right side. The set of 2D asymmetric data and the set of 3D data may be established such that values associated with the left side may differ from values associated with the right side in response to variation between the terrain profiles during traversal of the vehicle along the respective one or more first and second routes.

In any implementations, more than half of the training data utilized to train the at least one machine learning model, subsequent to training the at least one machine learning model with the set of 3D data, may include the set of 2D symmetric data and/or the set of 2D asymmetric data.

In any implementations, the method may include generating the set of 2D symmetric data, generating the set of 2D asymmetric data, and/or generating the set of 3D data.

In any implementations, the method may include obtaining virtual sensor information from one or more virtual sensors operable to measure a condition of a virtual instance of the respective one or more vehicle components. The method may include generating the set of 2D symmetric data. The set of 2D asymmetric data and/or the set of 3D data may be based on the virtual sensor information.

In any implementations, the at least one machine learning model may include first, second and third machine learning models. The step of training the at least one machine learning model with the set of 2D symmetric data may include training the first machine learning model. The step of training the at least one machine learning model with the set of 2D asymmetric data may include training the second machine learning model. The step of training the at least one machine learning model with the set of 3D data may include training the third machine learning model. One or more output nodes of the first machine learning model and one or more output nodes of the second machine learning model may be connected to respective input nodes of the third machine learning model. The determining step may be performed by the third machine learning model based on one or more outputs of the first machine learning model and one or more outputs of the second machine learning model.

In any implementations, the method may include obtaining real sensor information measured by one or more physical sensors during vehicle operation. The training step may include training the at least one machine learning model with the real sensor information.

In any implementations, the method may include obtaining determining a health of a physical instance of the respective one or more vehicle components based on the trained at least one machine learning model.

In any implementations, the method may include obtaining predicting a health of a physical instance of the respective one or more vehicle components based on the trained at least one machine learning model.

In any implementations, the at least one machine learning model may include an artificial neural network.

In any implementations, the at least one machine learning model may include one or more intermediate layers. One or more intermediate layers may include one or more recursion layers and/or one or more convolution layers.

In any implementations, the at least one machine learning model may be a time-series type model.

In any implementations, the one or more determined parameters may include wheel motion, hull motion, absorbed power, and/or damping with respect to absorbed power.

In any implementations, an instance of the at least one machine learning model may be associated with a first vehicle component. A second instance of the at least one machine learning model may be associated with a second vehicle component. The first and second components may be associated with a common side of the vehicle. The first instance of the at least one machine learning model may establish a first digital twin which may be utilized to determine the one or more parameters associated with the second vehicle component. The second instance of the at least one machine learning model may establish a second digital twin which may be utilized to determine the one or more parameters associated with the first vehicle component.

In any implementations, the method may include determining, using the trained machine learning model, a route plan based on the determined one or more parameters.

In any implementations, the method may include training the at least one machine learning model with terrain data associated with the one or more first routes and/or the one or more second routes.

In any implementations, the method may include communicating terrain data from a physics-based engine. The method may include communicating the terrain data to the input layer of the trained machine learning model. The method may include determining, using the trained machine learning model, the one or more parameters based on the terrain data. The method may include communicating the one or more determined parameters to the physics-based engine.

A system for determining vehicle mobility may include a computing device including one or more processors coupled to memory. The one or more processors may be collectively operable to execute a vehicle mobility capability engine. The vehicle mobility capability engine may be operable to train at least one machine learning model with a set of 2D symmetric data and/or a set of 2D asymmetric data associated with traversal of a vehicle along one or more first routes. The at least one machine learning model may include an input layer and an output layer. The input layer may include input nodes associated with one or more vehicle components of the vehicle. The vehicle mobility capability engine may be operable to train the at least one machine learning model with a set of 3D data associated with traversal of a vehicle along one or more second routes. The vehicle mobility capability engine may be operable to determine, using the trained machine learning model, one or more parameters associated with the one or more vehicle components in response to operation of the vehicle. The vehicle may include a left side and a right side. The left and right sides may include one or more respective wheels. The one or more first routes may be linear such that the set of 2D symmetric data may include values associated with pitch but may lack values associated with roll or yaw of the vehicle. The set of 2D symmetric data may be established such that values associated with the left and right sides may be equal to each other. The set of 2D asymmetric data and the set of 3D data may be established such that values associated with the left side may differ from values associated with the right side. The one or more second routes may be non-linear such that the set of 3D data may include values associated with yaw, pitch and roll.

In any implementations, the at least one machine learning model may include an artificial neural network.

In any implementations, the vehicle mobility capability engine may be operable to train the at least one machine learning model with terrain data associated with the one or more first routes and/or the one or more second routes.

A non-transitory computer-readable medium with instructions stored therein which, when collectively executed by one or more processors, may direct the one or more processor to train at least one machine learning model with a set of 2D symmetric data and/or a set of 2D asymmetric data associated with traversal of a vehicle along one or more first routes. The at least one machine learning model may include an input layer and an output layer. The input layer may include input nodes associated with one or more vehicle components of the vehicle. The instructions which, when collectively executed by one or more processors, may train the at least one machine learning model with a set of 3D data associated with traversal of a vehicle along one or more second routes. The instructions which, when collectively executed by one or more processors, may determine, using the trained machine learning model, one or more parameters associated with the one or more vehicle components in response to operation of the vehicle. The vehicle may include a left side and a right side. The left and right sides may include one or more respective wheels. The one or more first routes may be linear such that the set of 2D symmetric data may include values associated with pitch but may lack values associated with roll or yaw of the vehicle. The set of 2D symmetric data may be established such that values associated with the left and right sides may be equal to each other. The set of 2D asymmetric data and the set of 3D data may be established such that values associated with the left side may differ from values associated with the right side. The one or more second routes may be non-linear such that the set of 3D data may include values associated with yaw, pitch and roll.

The present disclosure may include any one or more of the individual features disclosed above and/or below alone or in any combination thereof.

The various features and advantages of this disclosure will become apparent to those skilled in the art from the following detailed description. The drawings that accompany the detailed description can be briefly described as follows.

### BRIEF DESCRIPTION OF THE DRAWINGS

The embodiments will be better understood from the following detailed description with reference to the drawings, which are not necessarily drawn to scale and in which:

FIG. 1 discloses a mobility system including a machine learning model according to an implementation.

FIGS. 2A-2B disclose a set of routes according to an implementation.

FIGS. 3-4 discloses the machine learning model of FIG. 1 according to an implementation.

FIG. 5 discloses a method of training a machine learning model according to an implementation.

FIGS. 6-8 disclose sets of variables associated with motion of a vehicle.

FIG. 9 discloses a physics-based gaming engine according to an implementation.

FIG. 10 discloses a user interface of the system of FIG. 1 according to an implementation.

FIG. 11 discloses an arrangement of machine learning models according to an implementation.

Like reference numbers and designations in the various drawings indicate like elements.

### DETAILED DESCRIPTION

The techniques disclosed herein may be utilized to train a machine learning model for predicting aspects of vehicle mobility. In implementations, the machine learning model may be an artificial neural network (ANN). The machine learning model may be trained with two-dimensional (2D) and/or three-dimensional (3D) data. In implementations, 2D data may be used to (e.g., preliminarily) train the machine learning model prior to training the model with 3D data.

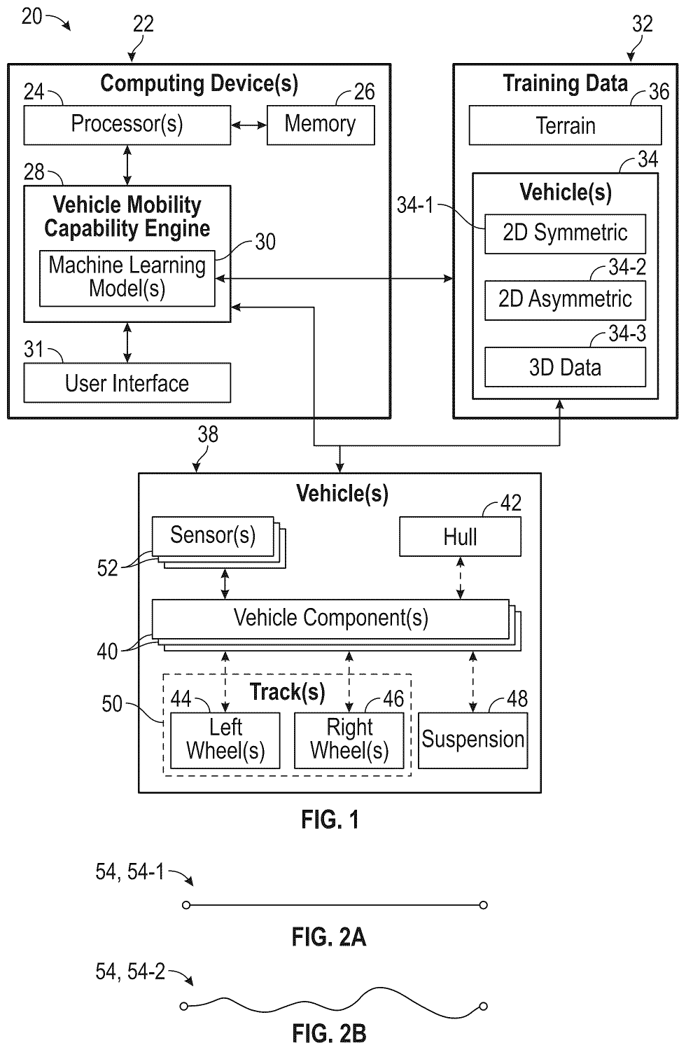

FIG. 1 discloses a mobility system 20 according to an implementation. The system 20 may be utilized to determine motion of vehicle component(s) associated with operation of a vehicle. Various vehicles may benefit from the teachings disclosed herein, including wheeled and tracked ground commercial and military vehicles.

The system 20 may include one or more computing devices 22. The computing device 22 may include one or more computer processors, memory, storage means, network devices, input and/or output devices, and/or interfaces. The computing device 22 may be operable to execute one or more software programs. The computing device 22 may be operable to communicate with one or more networks established by one or more computing devices. The memory may include UVPROM, EEPROM, FLASH, RAM, ROM, DVD, CD, a hard drive, or other computer readable medium which may store data and/or the functionality of this description. The computing device 22 may be a desktop computer, laptop computer, smart phone, tablet, or any other computer device. Input devices may include any of the input devices disclosed herein, such as a keyboard, mouse, touchscreen, etc. The input devices may include one or more sensors, including any of the sensors disclosed herein. The output devices may include any of the output devices disclosed herein, such as a monitor, speakers, printers, etc. The output devices may be operable to communicate to other computing systems and/or communications buses. The computing device 22 may include one or more processors 24 coupled to memory 26. The connection may be a wired and/or wireless connection. The connection may be established over one or more networks and/or other computing systems. The computing device 22 may be programmed with logic to perform any of the functionality disclosed herein. In implementations, processing of the various data and other information disclosed herein may be performed by the computing device 22 either onboard and/or offboard the vehicle.

The system 20 may include a vehicle mobility capability engine (e.g., environment) (VMCE) 28. The VMCE 28 may be operable to determine motion of one or more vehicle component(s) associated with operation of a vehicle. The VMCE 28 may include one or more machine learning models 30. Various machine learning models may be utilized, including any of the machine learning models disclosed herein.

The VMCE 28 and/or another portion of the system 20 may be operable to train the machine learning model 30. The machine learning model 30 may be trained utilizing any of the techniques disclosed herein. The machine learning model 30 may be trained with training data 32. The training data 32 may include any of the training data disclosed herein. The training data 32 may include vehicle data 34 and/or terrain data 36. The terrain data 36 may be associated with one or more 2D and/or 3D terrain profiles. The vehicle data 34 may include one or more data sets. The vehicle data 34 may include one or more sets of 2D symmetric data 34-1, 2D asymmetric data 34-2 and/or 3D data 34-3. The vehicle data 34 may be generated by one or more vehicle simulations and/or may be real data collected during operation of a vehicle.

The system 20 may be associated with one or more vehicles 38. The vehicle 38 may be simulated and/or may be a physical vehicle. The vehicle 38 may include one or more vehicle components 40. Various components may include wheels, drive sprockets, tracks, engine components, transmission components, etc. Various vehicle components 40 may be incorporated into the vehicle 38, including a body (e.g., hull) 42, a first (e.g., left) set of wheel(s) 44, a second (e.g., right) set of wheel(s) 46 and suspension 48 component(s). The suspension 48 may include an adaptive suspension configuration. The vehicle components 40 may include one or more tracks 50 associated with the respective sets of wheels 44, 46.

The vehicle 38 may be associated with one or more sensors 52. The sensors 52 may be operable to measure a condition of the vehicle 38 and/or one or more of the vehicle components 40. The sensors 52 may include any of the sensors disclosed herein. The sensors 52 may include a physical instance of a sensor and/or may include a virtual instance of a sensor associated with a physical instance of the sensor. The sensors may include a gyroscope and/or accelerometer, which may be operable to determine movement of the vehicle component(s) 40. The sensors may include a potentiometer, pressure sensor and/or displacement sensor. The machine learning model 30 may be trained with virtual and/or real sensor information associated with different component (e.g., suspension) configurations for the same and/or different vehicles and/or vehicle types.

Referring to FIGS. 2A-2B, with continuing reference to FIG. 1, the training data 32 may be associated with one or more vehicle routes 54. The routes 54 may include a first route 54-1 and/or a second route 54-2. The route 54 may be preselected prior to operation of the vehicle 38 or may be representative of a route executed by the vehicle 38. In implementations, the vehicle route 54 may have a length, such as 1000 feet. A 3D training set associated with the 3D data 34-3 for a 1000 foot path may take about 8 hours to generate using computing resources. A 2D training set associated with the 2D symmetric data 34-1 and/or 2D asymmetric data 34-2 may include about 400 iterations of the 1000 foot path, which may be generated in about 5 minutes using the same computing resources.

In implementations, the preliminary training of the machine learning model 30 may include training the model 30 with the 2D data set(s) 34-1 and/or 34-2 and/or training the model with 3D data set(s) 34-3 associated with a linear route (e.g., path). The linear route may exclude any turns (e.g., FIG. 2A). The first route 54-1 may be associated with the 2D symmetric data 34-1 and/or 2D asymmetric data 34-2 (see FIG. 2A). The second route 34-2 may be associated with the 3D data 34-3 (see FIG. 2B). The preliminarily trained machine learning model 30 may be trained with the 3D data set 34-3 associated with a non-linear route (e.g., path). The non-linear route may include one or more turns (e.g., FIG. 2B).

The machine learning model 30 may be utilized to determine (e.g., estimate) system performance. Various systems may benefit from the techniques disclosed herein, including automotive (e.g., autonomy), defense (e.g., tracked and wheeled vehicles), etc. The model 30 may be utilized to predict the motion of any component of a vehicle that may move during operation, including any of the vehicle components 40.

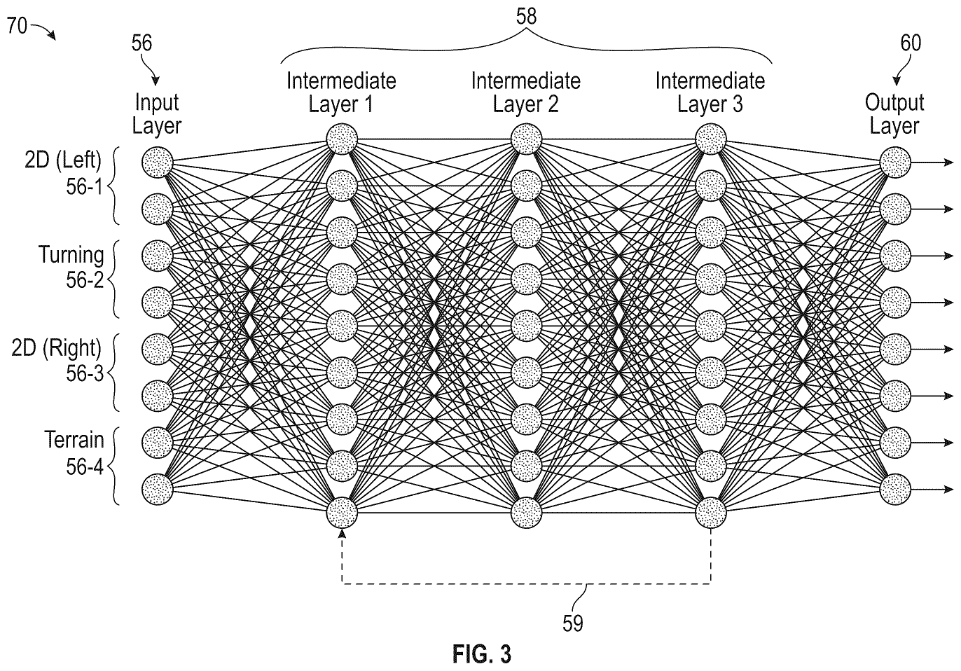

Referring to FIG. 3, with continuing reference to FIG. 1, the machine learning model 30 may including an artificial neural network (ANN). The neural network 30 may include an input layer 56, one or more intermediate (e.g., hidden) layers 58 and an output layer 60. The input layer 56 may include one or more input nodes operable to receive fixed input(s) and/or variable input(s). Values of the fixed input(s) may remain the same, but the variable input(s) may differ during vehicle operation. Fixed inputs may include a spring rate of an associated spring. Variable inputs may include ride height, damping setting(s), engine torque, etc. The output layer 60 may include one or more output nodes. The VMCE 28 may be operable to communicate the output(s) to one or more portions of the system 20, such as a vehicle controller, route planner, prognostics/diagnostics module, etc.

The input layer 56 may include a left set of input nodes 2D(Left) 56-1, turning node(s) 56-2 and/or a right set of input node(s) 2D(Right) 56-3. In implementations, the input layer 56 may include one or more terrain input nodes 56-4. The left set of input nodes 2D(Left) 56-1 may be associated with the left set of wheels 44. The right set of input nodes 2D(Right) 56-3 may be associated with the right set of wheels 46. The turning nodes 56-2 may be associated with the left and/or right sets of wheels 44, 46. The terrain nodes 56-4 may be associated with the terrain data 36. The machine learning model 30 may be a time-series type model, which may sample input(s) to the model 30 at a specified time increment.

Various techniques may be utilized to generate the training data 32. The training data 32 may be generated by vehicle simulation and/or may be real world data obtained during operation of a physical vehicle.

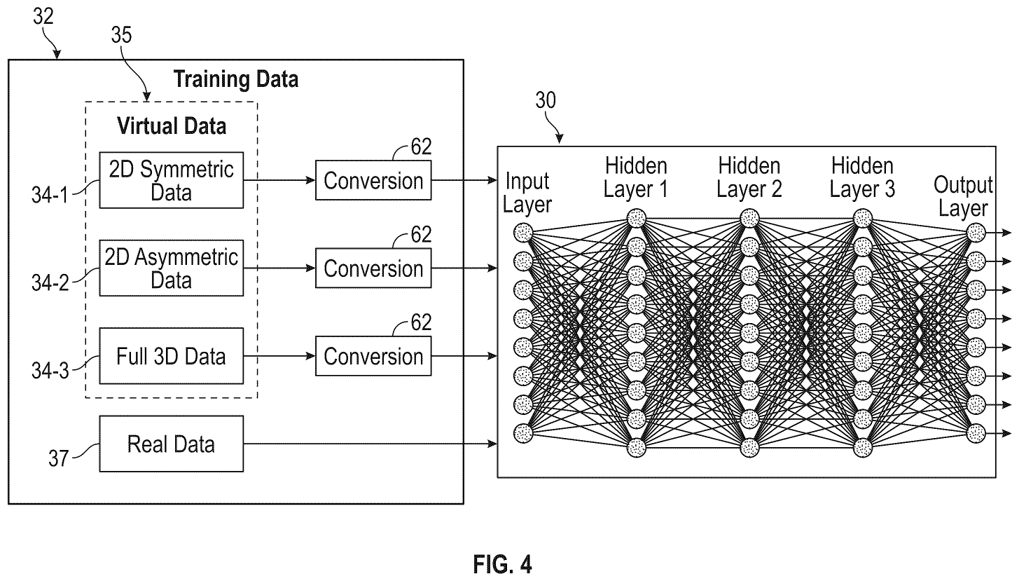

Referring to FIG. 4, with continuing reference to FIGS. 1 and 3, the training data 32 may include virtual (e.g., simulation) data 35 and/or real data 37. The virtual data 35 may include the 2D symmetric data 34-1, the 2D asymmetric data 34-2 and/or 3D data 34-3. The data sets associated with the input nodes of the input layer 56 may include the 2D symmetrical data set(s) 34-1, the 2D asymmetric data set(s) 34-2, the 3D data set(s) 34-3 and/or real data set(s) 56-4.

The 2D and 3D data may be normalized to a common origin. In implementations, the 2D and 3D data may be generated (e.g., measured) relative to a center of gravity of the respective 2D and 3D vehicle model. The 2D and 3D world may reference the same origin relative to the same vehicle model.

The VMCE 28 may include one or more conversion modules 62. The conversion modules 62 may be operable to translate the virtual data 35 into a common (e.g., real world) format. In implementations, the real world format may be associated with a condition measurable by a physical sensor 52 onboard the vehicle 38. Respective conversion modules 62 may be associated with the 2D symmetrical data set(s) 34-1, the 2D asymmetric data set(s) 34-2 and/or the 3D data set(s) 34-3. Utilizing the techniques disclosed herein, virtual data 35 associated with one or more virtual sensors 52 may be correlated to real world sensor 52 implementations.

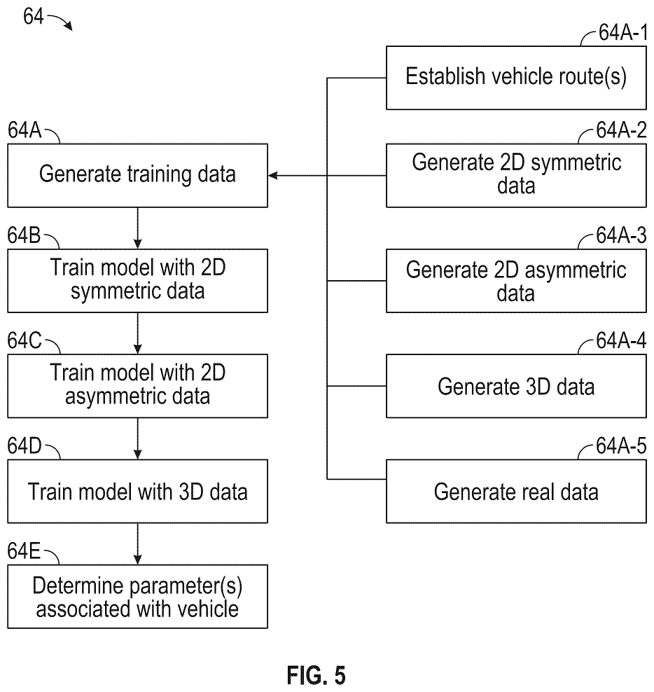

FIG. 5 discloses a method of training a machine learning model in a flowchart 64 according to an implementation. The method 64 may be utilized to train various machine learning models, including any of the machine learning models disclosed herein such as the model 30. The method 64 may incorporate any of the techniques disclosed herein. Fewer or additional steps than are recited below could be performed within the scope of this disclosure, and the recited order of steps is not intended to limit this disclosure. The VMCE 28 and/or another portion of the system 20 may be programmed with logic to execute any of the functionality of the method 64. Reference is made to the system 20 and model 30.

In implementations, the machine learning model 30 may be (e.g., preliminarily) trained with one or more sets of training data 32. The model 30 may then be further trained with one or more additional sets of training data 32. The training data 32 may be generated by one or more vehicle simulations and/or real world operation of a physical vehicle. The training data 32 may include sets of 2D and/or 3D data.

At block 64A, training data may be generated. Block 64A may include establishing one or more vehicle routes (e.g., routes 54) at block 64A-1. Block 64A may include generating 2D symmetric data set(s) 34-1 associated with operation of a vehicle at block 64A-2. In implementations, block 64A may include generating one or more virtual data sets (e.g., virtual data 35 of FIG. 4). Block 64A may include generating 2D asymmetric data set(s) 34-2 associated with operation of the vehicle at block 64A-3. Block 64A may include generating 3D data set(s) 34-3 associated with operation of the vehicle at block 64A-4. In implementations, block 64A may include generating one or more real data sets at block 64A-5 (e.g., real data 37 of FIG. 4).

Block 64A may include obtaining virtual sensor information from one or more virtual sensors 52 operable to measure a condition of a virtual instance of the respective vehicle component(s) 40. Block 64A may include generating the set(s) of 2D symmetric data 34-1, the set(s) of 2D asymmetric data 34-2 and/or the set(s) of 3D data 34-3 based on the virtual sensor information. Block 64A may include obtaining real sensor information measured by one or more physical sensors 52 during vehicle operation. Block 64B, 64C and/or 64D may include training the machine learning model 30 with the virtual and/or real sensor information. In implementations, the machine learning model 30 may be trained with virtual sensor information and then with real sensor information.

Various techniques may be utilized to generate the 2D data and/or 3D data. A virtual and/or physical instance of one or more sensors 52, such as a gyroscope and/or accelerometer, may be utilized to generate the 2D data. The physical sensor(s) 52 may be associated with the respective virtual sensor(s) 52. The associated vehicle 38 may include left and right sets of wheels 44, 46 and/or respective tracks 50. The 2D symmetric data 34-1 may include (e.g., left and right) sets of 2D data. In the implementation of FIG. 3, inputs 2D(Left) 56-1 may be associated with the left set of 2D data. Inputs 2D(Right) 56-3 may be associated with the right set of 2D data. The left and rights sets of 2D data may be the same (e.g., symmetric) or may differ (e.g., asymmetric).

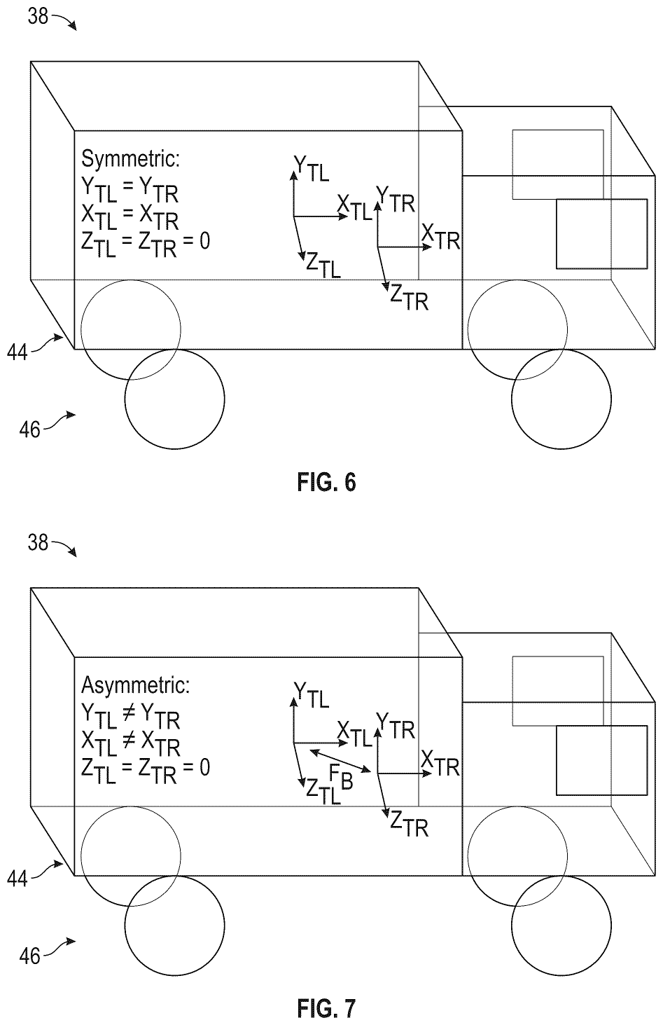

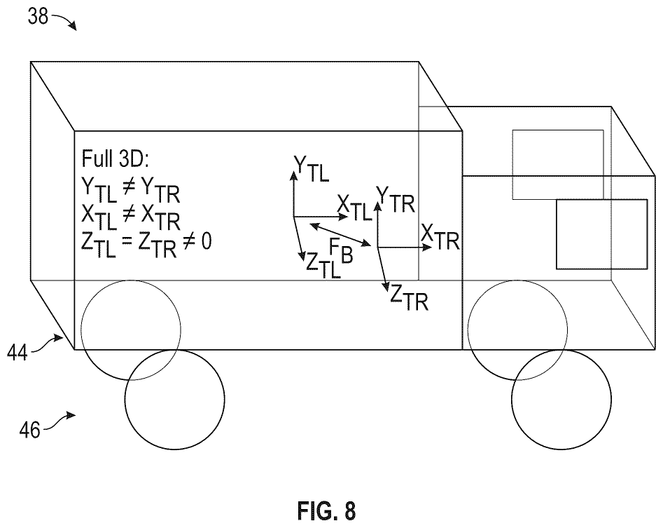

Referring to FIGS. 6-8, with continuing reference to FIGS. 1 and 3-5, the left and right data sets and associated inputs 2D(Left), 2D(Right) 56-1, 56-3 may be associated with respective set(s) of variables X_{TL}, Y_{TL}, Z_{TL} and X_{TR}, Y_{TR}, Z_{TR} of a vehicle, which may be defined with respect to a (e.g., standard) coordinate system X, Y, Z. The coordinate system X, Y, Z may be established relative to a center of gravity or another position associated with the respective vehicle. FIG. 6 discloses sets of variables that may be associated with movement of a vehicle and/or respective component(s) of the vehicle. The set(s) of variables may be associated with the 2D symmetric data 34-1. FIG. 7 discloses the variables X_{TL}, Y_{TL}, Z_{TL} and X_{TR}, Y_{TR}, Z_{TR} that may be associated with the 2D asymmetric data 34-2. FIG. 8 discloses the variables X_{TL}, Y_{TL}, Z_{TL} and X_{TR}, Y_{TR}, Z_{TR} that may be associated with the 3D data 34-3.

The variables Y_{TL} and Y_{TR} may be associated with translation along the Y-axis for the left and right sides of vehicle 38, respectively, and may be associated with vertical motion of the vehicle 38. The variables X_{TL} and X_{TR} may be associated with translation along the X-axis for the left and right sides of vehicle 38, respectively, and may be associated with forward and/or backward motion of the vehicle 38. The variables Z_{TL} and Z_{TR} may be associated with translation along the Z-axis for the left and right sides of the vehicle 38, respectively, and may be associated with side shifting of the vehicle 38. The variables Y_{RL} and Y_{RR} may be associated with rotation about the Y-axis for the left and right sides of the vehicle 38, respectively, and may be associated with vehicle yaw. The variables X_{RL} and X_{RR} may be associated with rotation about the X-axis for the left and right sides of the vehicle 38, respectively, and may be associated with vehicle roll. The variables Z_{RL} and Z_{RR} may be associated with rotation about the Z-axis for the left and right sides of the vehicle 38, respectively, and may be associated with vehicle pitch.

In symmetric mode, the data associated with the left and right sides of the vehicle 38 may be identical, and the terrain profile may be identical. Based on this symmetry, in implementations, generating the 2D symmetric data 34-1 at block 64A-2 may include generating the data for one (e.g., left) side of the vehicle 38 and then duplicating the data for the other (e.g., right) side of vehicle 38, which may reduce computational resources to generate the 2D symmetric data 34-1.

In the symmetric mode, values associated with components of the training data 34-1 may be associated with the following. Variable Y_{TL} may equal Y_{TR} associated with vehicle vertical motion. Variable X_{TL} may equal X_{TR} associated with vehicle forward and/or backward motion. Variables Z_{TL} and Z_{TR} may be equal and may be set to zero associated with vehicle side shifting. Variables Y_{RL} and Y_{RR} may be equal and may be set to zero associated with vehicle yaw. Variables X_{RL} and X_{RR} may be equal and may be set to zero associated with vehicle roll. Variables Z_{RL} and Z_{RR} may be equal and may include non-zero value(s) associated with vehicle pitch.

The 2D data sets 34-1 and/or 34-2 may be associated with a substantially or completely linear line route (e.g., path) of a vehicle 38. For the purposes of this disclosure, the terms “substantially”, “about” and “approximately” mean ±10 percent of the stated value or relationship unless otherwise indicated. The vehicle 38 may encounter various obstacles along the linear line path, such as bumps, etc. The input node(s) 56 and/or output node(s) 60 of the model 30 associated with turning may be set equal to zero since the path may extend along a straight line. The turning inputs 56-2 of the model 30 including the variables Z_{TL}, Z_{TR} associated with the 2D symmetric data 34-1 and/or 2D asymmetric data 34-2 may be set to zero.

The 2D asymmetric data 34-2 may include (e.g., left and right) sets of 2D data, which may be associated with the respective left and right input nodes 56-1, 56-3 of the model 30. The left and rights sets of 2D data may differ from each other. In implementations, the left and right sets of 2D data may be associated with different terrain profiles encountered during traversal of the vehicle 38 along the path. The left and right data sets may be associated with respective left and right rigid bodies of a simulated vehicle model. The left and right rigid bodies may be associated with a linkage (e.g., interdependency) in the vehicle model. The interdependency may be associated with a resolved force balance R_{B}. (e.g., FIGS. 7-8). Variable F_{B} may be associated with a force balance reacted between the left and right sides (e.g., wheels 44, 46) of the vehicle 38. Variable X_{RB} may be associated with rotational movement about the X-axis balanced between the variables X_{RL} and X_{RR}. Variable Z_{RB} may be associated with rotational movement about the X-axis balanced between the variables Z_{RL} and Z_{RR}.

The 2D asymmetric data 34-2 generated by simulation may be associated with a representation of real world driving without turning (e.g., straight line driving). An additional force and moment may be added in the force balance in the asymmetric simulation to account for the forces of the left and right rigid bodies acting on one another. The input node(s) 56 and/or output node(s) 60 of the model 30 and 2D asymmetric data 34-2 associated with turning may be set equal to zero since the path may extend along a straight line. In the implementation of FIG. 7, values of the variables Y_{TL} and Y_{TR} associated with the respective left and right sides may be the same or may differ from each other. Values of the variables X_{TL} and X_{TR} associated with the respective left and right sides may be the same or may differ from each other. Variable X_{RB} may be equal to a sum of the variables X_{RL} and X_{RR} associated with vehicle roll. Variable Z_{RB} may be equal to a sum of the variables Z_{RL} and Z_{RR}. Variable F_{B} may be set to zero since the 2D asymmetric data 34-2 may disregard movement of the vehicle 38 in the Z direction.

In implementations, the training data 34 associated with blocks 64A-2 and 64A-3 may be associated with at least approximately 50%, such as approximately 70-90%, of the training data 32 used to train the model 30, which may reduce overall computation cost in generating the training data 32. Generation of the turning data may be relatively computationally expensive. The disclosed techniques may be utilized to reduce the overall amount of turning data generated to train the model 32.

The method may include generating one or more sets of 3D data 34-3 associated with turning during operation of the vehicle 38 at block 64A-4. The 3D data 34-3 may be generated by one or more simulations of a vehicle model and/or real world operation of a physical vehicle. In implementations, the model 30 may be trained with simulated data and subsequently with real world data. The 3D data set 34-3 may be associated with a non-linear path (e.g., route) of the vehicle 38. The path may include one or more linear segments and one or more turns (e.g., undulations) (e.g., FIG. 2B). The vehicle 38 may encounter different (and/or the same) terrain on the left and right sides (e.g., tracks or sets of wheels) during execution of the path. In implementations, the left and right sets of 2D data may be associated with different (or the same) terrain profiles encountered during traversal of the vehicle along the path. More than half of the training data 32 utilized to train the machine learning model 30, subsequent to training the machine learning model 30 with the set(s) of 3D data 34-3, may include the set(s) of 2D symmetric data 34-1 and/or the set(s) of 2D asymmetric data 34-2. In implementations, at least approximately 50 percent, or more narrowly at least approximately 70 percent, or even more narrowly at least approximately 90 percent of the training data 32 utilized to train the machine learning model 30, subsequent to training the machine learning model 30 with the set of 3D data 34-3, may include the set(s) of 2D symmetric data 34-1 and/or the set(s) of 2D asymmetric data 34-2.

Various techniques may be utilized to generate the 3D data. A virtual and/or physical instance of one or more sensors, such as a gyroscope and/or accelerometer, may be utilized to generate the 3D data, including the turning data. The turning data and associated input node(s) 56-2 of the model 30 may include non-zero values associated with turning along a vehicle route (e.g., path).

In full 3D mode, the left and right vehicle sides of vehicle 38 may be the same or may differ. The terrain profiles encountered by the left and right sides may be the same or may differ. The 3D training data 34-3 may include turning along the respective vehicle route.

In the implementation of FIG. 8, values of the variables Z_{TL} and Z_{TR} associated with the respective left and right sides may be the same or may differ from each other, and may be associated with vehicle side shifting. Values of the variables Y_{RL} and YR_{R} associated with the respective left and right sides may be same and may include non-zero values associated with vehicle yaw (e.g., turning). In implementations, cross vehicle reactions associated with the left and right rigid bodies may be determined.

The method 64 may include training the model 30 with the training data 32. At block 64B, the model 30 may be (e.g., preliminarily) trained with the 2D symmetric data set(s) 34-1. The 2D symmetric data set(s) 34-1 may lack turning data. At block 64C, the model 30 may be trained with the 2D asymmetric data set(s) 34-2. The 2D asymmetric data set(s) 34-2 may lack turning data. At block 64D, the model 30 may be trained with the 3D data set(s) 34-3. The 3D data set(s) 34-3 may include turning data. In implementations, the 2D symmetric data set(s) 34-1 and/or 2D asymmetric data set(s) 34-2 may be associated with a first vehicle route. The 3D data set(s) 34-3 may be associated with a second vehicle route, which may be the same or may differ from the first vehicle route. The first route may be linear such that the set(s) of 2D symmetric data 34-1 and/or 2D asymmetric data 34-2 may include values associated with roll and/or pitch of the vehicle 38 but may lack values associated with yaw of the vehicle 38. The second route may include one or more undulations such that the set of 3D data 34-3 may include values associated with yaw, pitch and roll of the vehicle 38. The first route and/or the second route may be associated with different terrain profiles relative to the left side and the right side of the vehicle 38. The set of 2D asymmetric data 34-2 and the set of 3D data 34-3 may be established such that values associated with the left side of the vehicle 38 may differ from values associated with the right side of the vehicle 38 in response to variation between the terrain profiles during traversal of the vehicle 38 along the respective first and second routes. The terrain inputs 56-4 of the model 30 (FIG. 3) may include height at respective locations along a path (e.g. at start, 100 feet, 200 feet, etc.). The height value may be input into the model 30 at the specified time increment. In implementations, the method 64 may include training the model 30 by performing two or more iterations of block 64B, then training the model 30 by performing two or more iterations of block 64C, and then training the model 30 by performing two or more iterations of block 64D. Method 64 may include training the model 30 with block(s) of 2D symmetric data, then with block(s) of 2D asymmetric data, and then with block(s) of 3D data. Each block of data may be associated with execution of two or more routes, such as at least 100 routes, or more narrowly at least 1000 routes. The (e.g., sets) of routes within the same block of data and/or between the blocks of 2D symmetric, 2D asymmetric and/or 3D data may be the same or may differ from each other. The routes may differ by location, length, etc. The method 64 may include training the model 30 at block 64B with the block(s) of 2D symmetric data, then may include training the model 30 at block 64C with the block(s) of 2D asymmetric data, and then training the model 30 at block 64D with the block(s) of 3D data.

At block 64E, one or more parameters associated with the vehicle 38 may be determined using the trained machine learning model 30. Block 64E may include determining, using the trained machine learning model 30, one or more parameters associated with the vehicle and/or one or more associated vehicle components in response to operation of the vehicle 38, including any of the vehicle components disclosed herein. In implementations, the method 64 may include performing at least one (e.g., a first) iteration of steps 64B to 64E in sequence.

Various techniques may be utilized to establish the intermediate layer(s) 58 of the model 30. The intermediate layer(s) 58 may include “long short term memory.” The intermediate layer(s) 58 may include one or more recursion layers, one or more transformers, and/or one or more convolution layers. For recursion, the next vehicle state may be based on the current state of the vehicle 38. The current state of the vehicle 38 may be an input to the next vehicle state. The model 30 may have previous vehicle state(s) as input to the next step in a time series. In implementations, the output(s) of a subsequent intermediate layer 58 may be linked back as input(s) to an earlier intermediate layer 58 (e.g., link 59 of FIG. 3). In implementations, convolution may be applied to the terrain. Convolution layer(s) 58 may be applied to the terrain data 36 to provide a smooth input to the terrain input nodes 56-4, which may reduce a likelihood that the model 30 reacts to discrete noise in the terrain reading. The model 30 may evaluate the prior and/or upcoming terrain to determine if the vehicle 38 may be on an inclining or declining slope. Other machine learning models may be utilized, such as physics informed neural network models including Langrangian or Hamiltonian neural network models, and deep learning models such as transformer models.

The output layer 60 of the machine learning model 30 may be operable to generate one or more outputs associated with respective output node(s). the outputs may be associated with movement of the vehicle 38 and/or associated vehicle component(s) 40. The outputs may include wheel motion (e.g., two axes if assume rigid body, or three axes XYZ if include arm deflection). The outputs may include hull motion (e.g., six axes). The outputs may include absorbed power.

A majority of output(s) of the output layer 60 may be associated with respective vehicle input(s). In scenarios, outputs may be generated for fewer than all vehicle inputs, such as spring rate. The inputs and outputs to the machine learning model 30 may be interchanged (e.g., flipped). In implementations, the inputs and outputs may be interchanged to determine (e.g., predict) an optimal damping for absorbed power at a respective station of the vehicle (e.g., driver's station). In implementations, the model 30 may be initially optimized to have accuracy to training data prediction of vehicle performance/movement. Once the model 30 may be trained effectively, the model 30 may be utilized to accurately predict the damping settings that may minimize or otherwise reduce the absorbed power at a particular crew station, to limit the rotational movement of the platform (e.g., a sensor mast), etc. The model 30 may be utilized to control active damping valve(s) in the vehicle suspension 48. In implementations of the vehicle 38 including an electric motor, drive torque may be varied to stabilize the (e.g., sensor) platform, which may provide active drive stabilization.

The techniques disclosed herein may be utilized to perform various functions or tasks. The model 30 may be utilized to determine (e.g., predict) performance of the vehicle 38 across a specified (e.g., proposed) path (e.g., route) and/or for a specified mission and/or maneuver.

The model 30 may be utilized for prognostics and/or diagnostics of an associated vehicle. Block 64E may include determining a health of a physical instance of the respective vehicle component(s) 40 based on the trained machine learning model 30. Block 64E may include predicting a health of a physical instance of the respective vehicle component(s) 40 based on the trained machine learning model 30. Vehicle data may be utilized to establish a baseline for anomaly detection. In implementations, the model 30 may be trained based on data associated with a single wheel (e.g., wheel no. 1 associated with a set of 2-7 wheels of the respective side of the vehicle). The model outputs associated with the single wheel may be utilized to predict movement associated with the other wheels (e.g., wheels 2-7 of the respective side) and/or motion of a body (e.g., hull) 42 of the vehicle 38.

A digital twin may be established. The digital twin may be utilized to compare predicted output(s) from the model 30 to the real world data obtained during operation of the physical vehicle 38. The disclosed system 20 may be operable to determine whether the predicted output(s) match the real world data. In implementations, a different wheel (e.g., wheel no. 7) may be a second digital twin which may be used to predict movement associated with another wheel (e.g., wheel no. 1), which may be associated with the first digital twin (e.g., wheel no. 1), movement associated with other wheel(s) (e.g., wheels 2-6) and/or motion of the body 42 of the vehicle 38. The techniques disclosed herein may be utilized to establish two overlapping digital twins to provide fault detection for the input variables of the machine learning model 30. The second digital twin may be provided with different input variable(s) than the first digital twin, which may provide complete sensor coverage and may provide redundant predictions for the other wheels (e.g., wheels 2-6 on the same side).

The model 30 may be utilized to determine (e.g., predict) vehicle performance based on variability (e.g., do not assume an ideal vehicle). In implementations, the model 30 may be utilized to determine accuracy in configuring the vehicle 38 such as mounting a wheel during an assembly and/or maintenance operation.

The model 30 may be utilized for route planning. The model input(s) may include movement of wheel(s), absorbed power, etc. Absorbed power may be utilized to predict chassis vibration. In implementations, the model 30 may optimize for performance in executing a route instead of optimizing for accuracy (e.g., in predicting the same real world behavior of the vehicle). The model 30 may optimize for stability in performing the route, including setting various vehicle parameters such as speed, active suspension control, etc. The determined parameters may be utilized to determine a route plan. The model 30 may be utilized to predict a route score based on varying suspension and/or other component parameters across the route associated with the route plan (e.g., route 54).

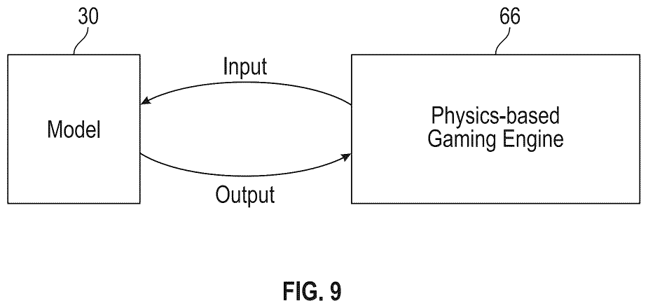

The disclosed techniques may be used for virtual prototyping (VPP). Referring to FIG. 9, with continuing reference to FIGS. 1 and 3, the model 30 may interface with a physics-based gaming engine 66, such as Unity or Unreal. The physics-based engine 66 may establish a vehicle model of a vehicle 38. Terrain information from the physics-based engine 66 may be provided as input(s) into the terrain input node(s) 56-4 of the machine learning model 30. Output(s) of the machine learning model 30 may be communicated as input(s) to the physics-based gaming engine 66, which may be utilized to more accurately predict vehicle dynamics. A physics-based model associated with a virtual instance of the vehicle 38 within the gaming engine 66 may be overridden with output(s) from the machine learning model 30. The method 64 may include communicating terrain data 32 from the physics-based engine 66. The method 64 may include communicating the terrain data 32 to the input layer 56 of the trained machine learning model 30. The method may include determining, using the trained machine learning model 30, the one or more parameters based on the terrain data 32. The method 64 may include communicating the one or more determined parameters to the physics-based engine 66, which may be utilized to simulate movement of the associated vehicle model.

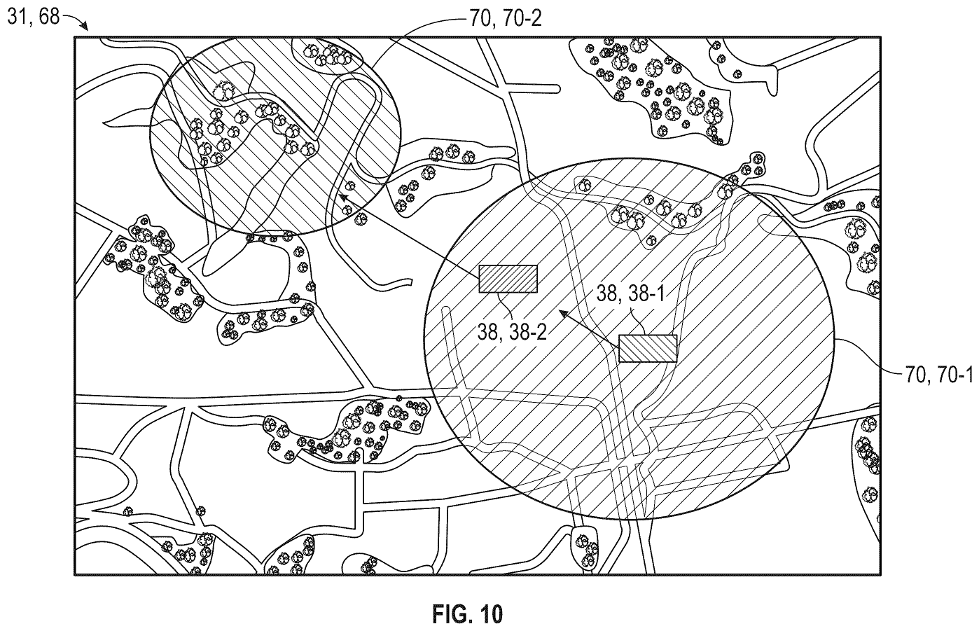

Referring to FIG. 10, with continuing reference to FIGS. 1 and 3, the system 20 may include a user interface 31. The user interface 31 may be operable to display a position of one or more vehicles 38 relative to a terrain (e.g., go/no-go) map 68 based on one or more (e.g., baseline) parameters, such as absorbed power and/or soft soil mobility. The vehicles 38 may include one or more friendly vehicles 38-1 and/or one or more enemy vehicles 38-2. The model 30 may be associated with the terrain map 68. The terrain data 36 may be associated with the terrain map 68. A limit of absorbed power may be defined, such as approximately 6 watts for human occupants in a U.S. military vehicle. A known simulation tool for determining absorbed power is the NATO Reference Mobility Model (NRMM). The machine learning model 30 may be operable to determine absorbed power. Absorbed power during vehicle operation may be determined for one or more stations of the vehicle 38 (e.g., driver) along a respective route. One or more localized regions 70 may be established along the terrain map 68. The localized regions 70 may include one or more go (e.g., accessible) regions 70-1 and/or no-go (e.g., inaccessible) regions 70-2. Absorbed power may be determined at positions along the terrain map 68 associated with the respective route for the friendly and/or enemy vehicles 38-1, 38-2. An operator may utilize tactics to push the enemy into a no-go zone 70-2 (e.g., rocky or muddy terrain, etc.) based on the absorbed power associated with the respective zone.

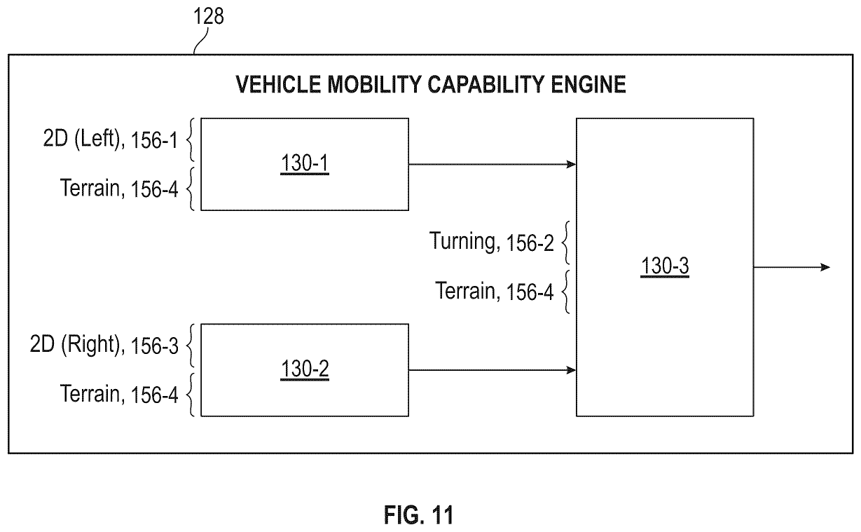

FIG. 11 discloses a vehicle mobility capability engine (e.g., environment) (VMCE) 128 according to another implementation. In this disclosure, like reference numerals designate like elements where appropriate and reference numerals with the addition of one-hundred or multiples thereof designate modified elements that are understood to incorporate the same features and benefits of the corresponding original elements. The VCME 128 may include a plurality (e.g., combination) of machine learning models 130. The machine learning models 130 may incorporate any of the features and/or machine learning models disclosed herein. In implementations, the machine learning models 130 may include first, second and/or third machine learning models 130-1, 130-2, 130-3. The models 130-1, 130-2 and/or 130-3 may be a neural network including an input layer, one or more intermediate (e.g., hidden) layers and an output layer.

The input layer of the first machine learning model 130-1 may include a left set of input nodes 2D(Left) 156-1 and/or one or more terrain input nodes 156-4. The input layer of the second machine learning model 130-2 may include a right set of input node(s) 2D(Right) 156-3 and/or one or more terrain input nodes 156-4. The input layer of the third machine learning model 130-3 may include one or more turning node(s) 156-2 and/or one or more terrain input nodes 156-4. The nodes 156-1, 156-2, 156-3, 156-4 may be operable to receive any of the information disclosed herein, including any of the information associated with the respective nodes 56-1, 56-2, 56-3 and/or 56-4 (e.g., FIG. 3). The functionality of the machine learning model 30 may be distributed between the machine learning models 130-1, 130-2 and/or 130-3.

The models 130-1, 130-2, 130-3 may be arranged in a cascade. The third model 130-3 may include one or more input nodes operable to receive one or more outputs from the output layer of the first model 130-1 and/or the second model 130-2. One or more output nodes of the first machine learning model 130-1 and/or one or more output nodes of the second machine learning model 130-2 may be connected to respective input nodes of the third machine learning model 130-3.

The models 130-1, 130-2, 130-3 may be operable to generate any of the outputs disclosed herein. The third model 130-3 may be operable to determine one or more parameters associated with one or more vehicle components in response to operation of the vehicle. The third model 130-3 may be operable to perform the determination based on one or more outputs of the first machine learning model 130-1 and/or one or more outputs of the second machine learning model 130-2.

The models 130-1, 130-2, 130-3 may be trained utilizing any of the techniques disclosed herein. Distributing the functionality between the machine learning models 130-1, 130-2, 130-3 may reduce a total number of connections associated with the input nodes, since the number of connections within a single neural network may grow exponentially as the number of input nodes increases. The machine learning models 130-1, 130-2, 130-3 may be trained in parallel, which may reduce computational time compared to training a single machine learning model including a number of input nodes equivalent to a total number of the input nodes of the machine learning models 130-1, 130-2, 130-3.

The foregoing description, for purpose of explanation, has been described with reference to specific arrangements and configurations. However, the illustrative examples provided herein are not intended to be exhaustive or to limit embodiments of the disclosed subject matter to the precise forms disclosed. Many modifications and variations are possible in view of the disclosure provided herein. The embodiments and arrangements were chosen and described in order to explain the principles of embodiments of the disclosed subject matter and their practical applications. Various modifications may be used without departing from the scope or content of the disclosure and claims presented herein.

Although the different examples have the specific components shown in the illustrations, embodiments of this disclosure are not limited to those particular combinations. It is possible to use some of the components or features from one of the examples in combination with features or components from another one of the examples.

Although particular step sequences are shown, described, and claimed, it should be understood that steps may be performed in any order, separated or combined unless otherwise indicated and will still benefit from the present disclosure.

What is claimed is:

1. A method for determining health for a vehicle comprising:
training at least one machine learning model with a set of 2D symmetric data and a set of 2D asymmetric data, the set of 2D symmetric data associated with traversal of a vehicle along one or more first routes, the at least one machine learning model including an input layer and an output layer, and the input layer including input nodes associated with one or more vehicle components of the vehicle; and
determining, using the trained at least one machine learning model, one or more parameters associated with the one or more vehicle components in response to operation of the vehicle;
wherein the vehicle includes a left side and a right side, the left and right sides including one or more respective wheels;
wherein the one or more first routes are linear such that the set of 2D symmetric data includes values associated with pitch but lacks values associated with roll or yaw of the vehicle, and wherein the set of 2D asymmetric data includes values associated with pitch and roll but lacks values associated with yaw of the vehicle.

2. The method as recited in claim 1, further comprising:
obtaining virtual sensor information from one or more virtual sensors operable to measure a condition of a virtual instance of the respective one or more vehicle components;
wherein the training step includes training the at least one machine learning model with the virtual sensor information.

3. The method as recited in claim 1, wherein:
the set of 2D symmetric data is established such that values associated with the left and right sides are equal to each other.

4. The method as recited in claim 1, further comprising:
training the at least one machine learning model with a set of 3D data associated with traversal of the vehicle along one or more second routes;
wherein the one or more second routes include one or more undulations such that the set of 3D data including values associated with yaw, pitch and roll of the vehicle.

5. The method as recited in claim 4, further comprising:
training the at least one machine learning model with terrain data associated with the one or more first routes and/or the one or more second routes.

6. The method as recited in claim 4, wherein:
the one or more first routes and/or the one or more second routes are associated with different terrain profiles relative to the left side and the right side;
the set of 2D asymmetric data and the set of 3D data is established such that values associated with the left side differ from values associated with the right side in response to variation between the terrain profiles during traversal of the vehicle along the respective one or more first and second routes; and
more than half of the training data utilized to train the at least one machine learning model, subsequent to training the at least one machine learning model with the set of 3D data, includes the set of 2D symmetric data and/or the set of 2D asymmetric data.

7. The method as recited in claim 6, further comprising:
generating the set of 2D symmetric data;
generating the set of 2D asymmetric data; and/or
generating the set of 3D data.

8. The method as recited in claim 7, further comprising:
obtaining virtual sensor information from one or more virtual sensors operable to measure a condition of a virtual instance of the respective one or more vehicle components; and
generating the set of 2D symmetric data, the set of 2D asymmetric data and/or the set of 3D data based on the virtual sensor information.

9. The method as recited in claim 6, wherein:
the at least one machine learning model includes first, second and third machine learning models;
the step of training the at least one machine learning model with the set of 2D symmetric data includes training the first machine learning model;
the step of training the at least one machine learning model with the set of 2D asymmetric data includes training the second machine learning model;
the step of training the at least one machine learning model with the set of 3D data includes training the third machine learning model;
one or more output nodes of the first machine learning model and one or more output nodes of the second machine learning model are connected to respective input nodes of the third machine learning model; and
the determining step is performed by the third machine learning model based on one or more outputs of the first machine learning model and one or more outputs of the second machine learning model.

10. The method as recited in claim 1, further comprising:
obtaining real sensor information measured by one or more physical sensors during vehicle operation; and
the training step includes training the at least one machine learning model with the real sensor information.

11. The method as recited in claim 1, further comprising:
determining a health of a physical instance of the respective one or more vehicle components based on the trained at least one machine learning model; and/or
predicting the health of the physical instance of the respective one or more vehicle components based on the trained at least one machine learning model.

12. The method as recited in claim 1, wherein:
the at least one machine learning model includes an artificial neural network;
the at least one machine learning model includes one or more intermediate layers, and one or more intermediate layers include one or more recursion layers, one or more transformers and/or one or more convolution layers; and/or
the at least one machine learning model includes a time-series type model.

13. The method as recited in claim 1, wherein:
the one or more determined parameters include wheel motion, hull motion, absorbed power, and/or damping with respect to absorbed power.

14. The method as recited in claim 1, wherein:
a first instance of the at least one machine learning model is associated with a first vehicle component;
a second instance of the at least one machine learning model is associated with a second vehicle component, the first and second components associated with a common side of the vehicle;
the first instance of the at least one machine learning model establishes a first digital twin utilized to determine the one or more parameters associated with the second vehicle component; and
the second instance of the at least one machine learning model establishes a second digital twin utilized to determine the one or more parameters associated with the first vehicle component.

15. The method as recited in claim 1, further comprising:
determining, using the trained machine learning model, a route plan based on the determined one or more parameters.

16. The method as recited in claim 1, further comprising:
communicating terrain data from a physics-based engine;
communicating the terrain data to the input layer of the trained machine learning model;
determining, using the trained machine learning model, the one or more parameters based on the terrain data; and
communicating the one or more determined parameters to the physics-based engine.

17. A system for determining vehicle mobility comprising:
a computing device including one or more processors coupled to memory, wherein the one or more processors are collectively operable to execute a vehicle mobility capability engine, and the vehicle mobility capability engine is operable to:
train at least one machine learning model with a set of 2D symmetric data and/or a set of 2D asymmetric data associated with traversal of a vehicle along one or more first routes, the at least one machine learning model including an input layer and an output layer, the input layer including input nodes associated with one or more vehicle components of the vehicle; and
determine, using the trained machine learning model, one or more parameters associated with the one or more vehicle components in response to operation of the vehicle;
wherein the vehicle includes a left side and a right side, the left and right sides including one or more respective wheels;
wherein the one or more first routes are linear such that the set of 2D symmetric data includes values associated with pitch but lacks values associated with roll or yaw of the vehicle, the set of 2D symmetric data is established such that values associated with the left and right sides are equal to each other, the set of 2D asymmetric data is established such that values associated with the left side differ from values associated with the right side.

18. The system as recited in claim 17, wherein the vehicle mobility capability engine operable to:
train the at least one machine learning model with the set of 2D symmetric data and the set of 2D asymmetric data.

19. The system as recited in claim 17, the vehicle mobility capability engine operable to:
train the at least one machine learning model with a set of 3D data associated with traversal of a vehicle along one or more second routes;
wherein the set of 3D data is established such that values associated with the left side differ from values associated with the right side, and the one or more second routes are non-linear such that the set of 3D data includes values associated with yaw, pitch and roll.

20. The system as recited in claim 19, the vehicle mobility capability engine is operable to:
determine, using the trained machine learning model, a route plan based on the one or more parameters.
